(19) United States
(12) Patent Application Publication
(10) Pub. No.: US 2007/0121016 A1
(43) Pub. Date: May 31, 2007

(54) Audio/video switch circuit using and I2C bus

(75) Inventors: Kuo-Ting Chiu, Taipei City (TW); Yu-Huei Cheng, Taipei City (TW); Tzu-Huei Lee, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/600,795

(22) Filed: Nov. 17, 2006

(30) Foreign Application Priority Data
Nov. 25, 2005 (TW) 094220509

(51) Int. Cl. H04N 5/268

(52) U.S. Cl. 348/705

(57) ABSTRACT

An audio/video switch circuit using the I²C bus includes a video decoder, an audio integrated circuit, an audio/video switch-unit and an MCU, in which the MCU is electrically connected to the audio/video switch unit through an I²C bus, allowing the control signals outputted by the MCU to be sent out to the audio/video switch unit through the I²C bus for controlling the switch of the audio/video switch unit, such that one of the input audio/video signals is outputted to the video decoder and the audio integrated circuit respectively through the switch of the audio/video switch unit.

### BACKGROUND OF THE INVENTION

1. Field of the Invention

The present invention relates to an audio/video switch circuit and, more particularly, to an audio/video switch circuit using an inter integrated circuit (I²C) bus.

2. Description of Related Art

FIG. 1 is a functional block diagram that demonstrates the conventional method of switching multiple audio/video signals, in which the circuit comprises multiple audio/video signal sources 10, a plurality of video switches 11, 12, an audio switch 13, a microcontroller unit (MCU) 14, a video decoder 15 and an audio integrated circuit 16. The video switches 11, 12 are electrically connected to the MCU 14. The audio switch 13 is electrically connected to the MCU 14, in which the video switches 11, 12 and the audio switch 13 are electrically connected to the input/output pins of the MCU 14. Also, the video switches 11, 12 are electrically connected to the video decoder 15, and the audio switch 13 is electrically connected to the audio integrated circuit 16.

The video switches 11, 12 and the audio switch 13 are configured to receive multiple audio/video signal sources 10. The MCU 14 controls the switch by both the video switches 11, 12 and the audio switch 13 through the input/output pins, such that the video signal that are intended to be outputted can pass through one of the video switches 11, 12 and be outputted to the video decoder 15 for decoding.

However, the above method requires several video switches 11, 12 and at least one audio switch 13 and that those video switches 11, 12 and the audio switch 13 take up too many input/output pins of the MCU 14, thus complicating the hardware design and the layout of the circuitry.

Therefore, it is desirable to come up with an improved audio/video switch circuit to overcome the aforementioned problems.

### SUMMARY OF THE INVENTION

One of the objectives of the present invention is to provide an audio/video switch circuit using an I²C bus, such that the number of input/output pins of an MCU to be used can be significantly reduced.

The other objective of the present invention is to provide an audio/video switch circuit using an I²C bus, such that the number of video switches and audio switches can be significantly reduced.

To achieve the objectives, the present invention provides an audio/video switch circuit controlled by an I²C bus. The audio/video switch circuit comprises a video decoder, an audio integrated circuit, an audio/video switch unit and an MCU. The aforementioned audio/video switch unit, which is configured to receive multiple audio/video input signals, includes a plurality of video signals and at least one audio signal and is electrically connected to the video decoder and the audio integrated circuit respectively. The MCU is electrically connected to the audio/video switch unit through an I²C bus, such that one of the audio/video input signals could be outputted, by switching the audio/video switch unit, to the video decoder and the audio integrated circuit.

Within the aforementioned audio/video switch circuit controlled by the I²C bus, the audio/video switch unit further comprises five input ports and two output ports.

### BRIEF DESCRIPTION OF THE DRAWINGS

FIG. 1 is a functional block diagram illustrating the prior art for the switch of multiple audio/video signals.

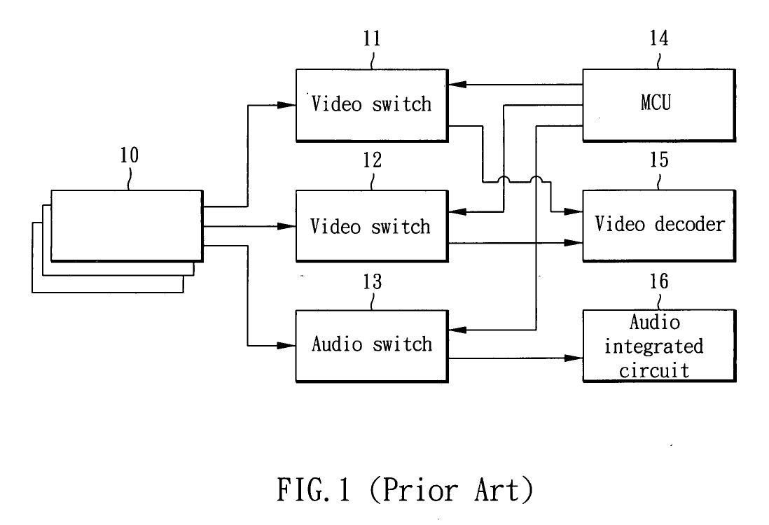

FIG. 2 is a functional block diagram illustrating a preferred embodiment according to the present invention.

FIG. 3 is a clock diagram showing an I²C bus basic operation.

### DETAILED DESCRIPTION OF THE PREFERRED EMBODIMENT

The audio/video switch circuit using an I2C bus can be used in a digital television or any video devices.

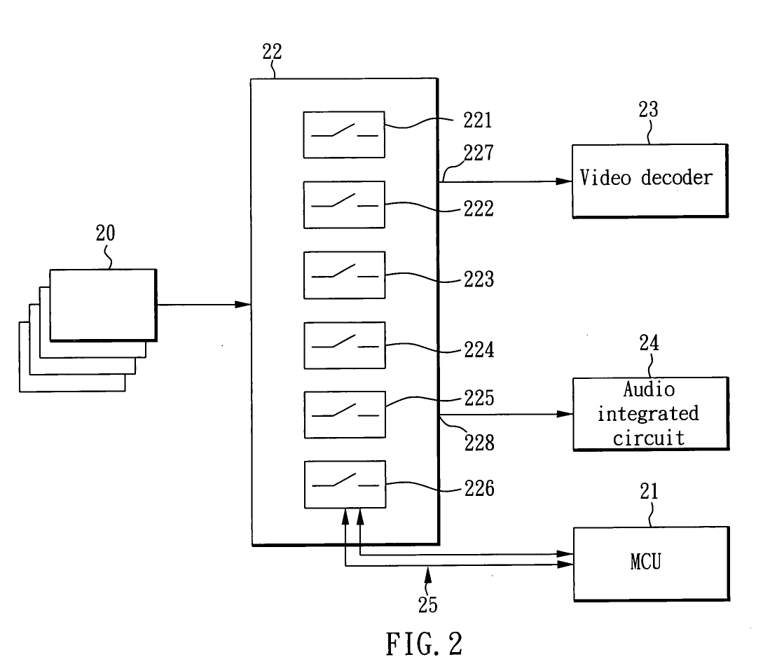

The preferred embodiment of the present invention is illustrated in FIG. 2 of a functional block diagram, in which the embodiment includes an MCU 21, an audio/video switch unit 22, a video decoder 23 and an audio integrated circuit 24.

The MCU 21 is electrically connected to the audio/video switch unit 22 through an I2C bus 25. The audio/video switch unit 22 is electrically connected to the video decoder 23 and the audio integrated circuit 24 respectively.

The audio/video switch unit 22 is configured to receive a plurality of audio/video signal sources 20, wherein each audio/video signal 20 can include either a video signal and an audio signal concurrently, one single video signal or one single audio signal.

The MCU 21 controls the switch of the audio/video switch unit 22 through its connection to the input/output pins of the I²C bus 25. Since the space occupied by the I²C bus 25 is rather small whilst the I²C bus 25 being able to be parallel connected to multiple controlled modules (e.g. the audio/video switch unit 22), the overall complication involved within the design in terms of the hardware and the circuitry layout, as well as the space occupied on the circuit board, can be significantly reduced. Besides, the MCU 21 is electrically connected to the audio/video switch unit through the I²C bus 25; therefore, the input/output pins of the MCU 21 occupied can be effectively reduced, allowing more input/output pins of the MCU 21 to become available for other uses.

The aforementioned I²C bus 25 further comprises a serial data line (SDA), which is configured to transmit address signals, and a serial clock line (SCL), which is configured to transmit control signals, for providing the switch of the audio/video switch unit 22 that is determined in accordance to the address signals and the control signals.

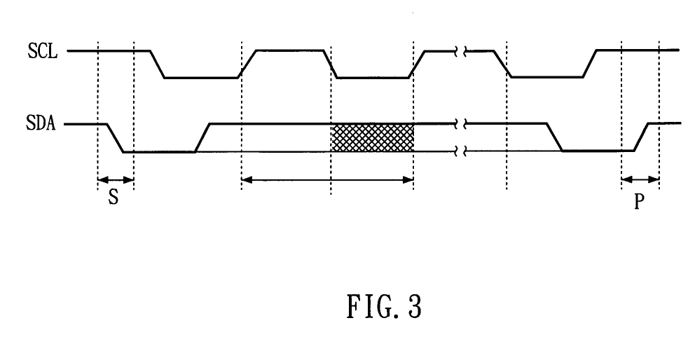

FIG. 3 is the clock diagram showing the basic operation of the I²C bus 25. Referring to FIG.2 and FIG. 3 together, the MCU 21 uses the SCL line to control the transmitting direction of the I²C bus 25 and also uses the SCL line to set up both START and STOP conditions: As the voltage of the SCL sets at HIGH, if the voltage of the SDA line changes from HIGH to LOW, it indicates a START condition. As the voltage of the SCL line sets at HIGH, if, on the other hand, the voltage of SDA line changes from LOW to HIGH, then it indicates STOP condition. During the period when the voltage of the SCL line is LOW, the status of the SDA can be altered.

The MCU 21 of the present invention is configured to control the switch by the audio/video switch unit 22 using the I²C bus 25. For further details regarding the switch by the audio/video switch unit 22, please continue referring to FIG. 2.

In the present invention, the audio/video switch unit 22 further comprises a plurality of internal switch units 221, 222, 223, 224, 225 and 226, wherein the internal switch units 221, 222, 223, 224 and 225 are configured to individually receive video signals from the audio/video signal source 20. The internal switch unit 226 is configured to receive audio signals from the audio/video signal source 20. In this embodiment the audio/video switch unit 22 includes a total of five input ports and two output ports, in which the first output port 227 of the audio/video switch unit 22 is electrically connected to the video decoder 23, and the second output port 228 of the audio/video switch unit 22 is electrically connected to the audio integrated circuit. In other embodiments the number of input ports and output ports of the audio/video switch unit 22 can be adjusted according to each different demand in practice.

The MCU 21 can receive a remote control signal from a user, for which the MCU 21 outputs a switch signal with respect to the remote control signal. The switch signal is then sent to the audio/video switch unit 22 by the MCU 22 through the I²C bus 25, such that one of the audio/video input signals is outputted, through the switching of the audio/video switch unit 22, to the video decoder 23 and the audio integrated circuit 24 respectively.

Therefore, to output a video display with its corresponding sound, a remote control can be used to output a control signal that is related to the intended video display and sound to the MCU 21, such that the desired graphics and sounds can be outputted using the MCU 21 and through the switch of the audio/video switch unit 22, and those undesired graphics and sounds can be blocked also with the MCU 21 and through the switch of the audio/video switch unit 22.

From above it is known that the present invention uses an audio/video signal unit to receive a plurality of audio/video signals. The audio/video switch unit is electrically connected to an MCU through an I²C bus, such that the MCU, via the I²C bus, can send out the switch signal to the audio/video switch unit in order to control the switch of that unit and output the desired graphics and/or sounds.

Although the present invention has been explained in relation to its preferred embodiment, it is to be understood that many other possible modifications and variations can be made without departing from the scope of the invention as hereinafter claimed.

What is claimed is:

1. An audio/video switch circuit using an I²C bus comprising:
a video decoder;
an audio integrated circuit;
an audio/video switch unit configured to receive a plurality of audio/video input signals and electrically connected to said video decoder and said audio integrated circuit respectively; and
an MCU electrically connected to said audio/video switch unit through an I²C bus, for which said MCU controls said audio/video switch unit, such that one of said audio/video input signals, through the switch of said audio/video switch unit, is outputted to said video decoder and said audio integrated circuit.

2. The audio/video switch circuit as claimed in claim 1, wherein said MCU receives a control signal, for which said MCU outputs a switch signal in accordance to said control signal and sends out said switch signal to said audio/video switch unit through said I²C bus to control the switch of said audio/video switch unit.

3. The audio/video switch circuit as claimed in claim 2, wherein said control signal is a remote control signal.

4. The audio/video switch circuit as claimed in claim 1, wherein said audio/video switch unit comprises five input ports.

5. The audio/video switch circuit as claimed in claim 1, wherein said audio/video switch unit comprises two output ports.

6. The audio/video switch circuit as claimed in claim 1, wherein said audio/video switch unit comprises a first output port, which is electrically connected to said video decoder, and a second output port, which is electrically connected to said audio integrated circuit.

7. The audio/video switch circuit as claimed in claim 1, wherein said audio/video input signals comprise a plurality of video signals and at least one audio signal.

8. The audio/video switch circuit as claimed in claim 1, wherein said audio/video switch circuit is used in a digital television.

9. The audio/video switch circuit as claimed in claim 1, wherein each of said audio/video signal comprises a video signal and an audio signal at the same time.

10. The audio/video switch circuit as claimed in claim 1, wherein each of said audio/video signal comprises only one single video signal.

11. The audio/video switch circuit as claimed in claim 1, wherein each audio/video signal comprises only one single audio signal.
